(19) United States
(12) Patent Application Publication
(10) Pub. No.: US 2011/0266814 A1
(43) Pub. Date: Nov. 3, 2011

(54) COVER LATCHING MECHANISM

(75) Inventor: XIAN-WU HUANG, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/884,230

(22) Filed: Sep. 17, 2010

(30) Foreign Application Priority Data
Apr. 30, 2010 (CN) 201010161051.4

(51) Int. Cl. E05C 19/08

(52) U.S. Cl. 292/129

(57) ABSTRACT

A cover latching mechanism includes a housing, a cover, a button and a spring. The button is slidably mounted to the housing and releasably latches with the cover. The spring is mounted between the button and the housing. When the button is pressed, the button slides relative to the housing to compress the spring and release the button from the cover.

### BACKGROUND

1. Technical Field

The disclosure generally relates to cover latching mechanisms.

2. Description of Related Art

Batteries are widely used in electronic devices, such as personal digital assistants (PDAs), and cellular phones. A typical latching structure is used to latch a battery cover to the electronic device to secure the battery between the battery cover and the electronic device. However, a typical latching structure may be hard to unlatch for exposing the battery for removal.

Therefore, there is a room for improvement within the art.

### BRIEF DESCRIPTION OF THE DRAWINGS

Many aspects of the exemplary cover latching mechanism can be better understood with reference to the following drawings. These drawings are not necessarily drawn to scale, the emphasis instead being placed upon clearly illustrating the principles of the exemplary cover latching mechanism. Moreover, in the drawings like reference numerals designate corresponding parts throughout the several views. Wherever possible, the same reference numbers are used throughout the drawings to refer to the same or like elements of an embodiment.

FIG. 1 is an exploded schematic view of a cover latching mechanism according to an exemplary embodiment.

FIG. 2 is an enlarged view of the cover latching mechanism of FIG. 1.

FIG. 3 is an assembled view of the electronic device shown in FIG. 2.

FIG. 4 is an assembled view of the electronic device shown in FIG. 1.

FIG. 5 is an enlarged cross-sectional view of the cover latching mechanism shown in FIG. 4 along the line V-V in a first state.

FIG. 6 is similar to the FIG. 5, but showing the cover latching mechanism in a second state.

### DETAILED DESCRIPTION

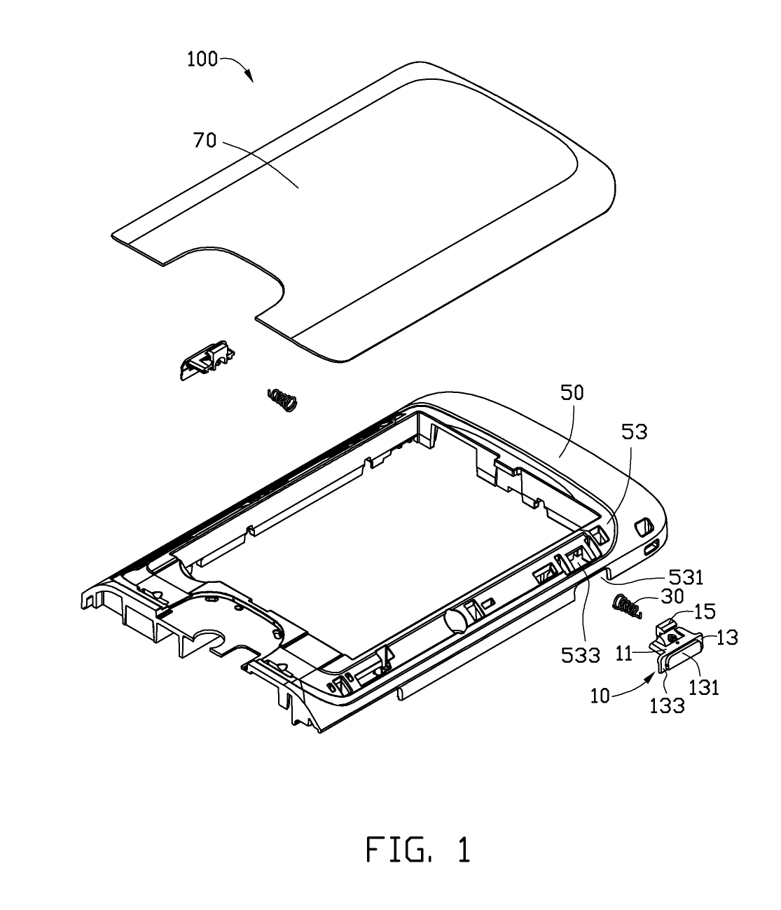

Referring to FIG. 1, an exemplary embodiment of a cover latching mechanism 100 includes one or more buttons 10, a spring 30 corresponding to each button 10, a housing 50 and a cover 70. In the present embodiment, two buttons 10 are used, one of which is slidably located at each side of the housing 50. Each spring 30 is disposed between their corresponding button 10 and the housing 50 to exert force on a corresponding button 10.

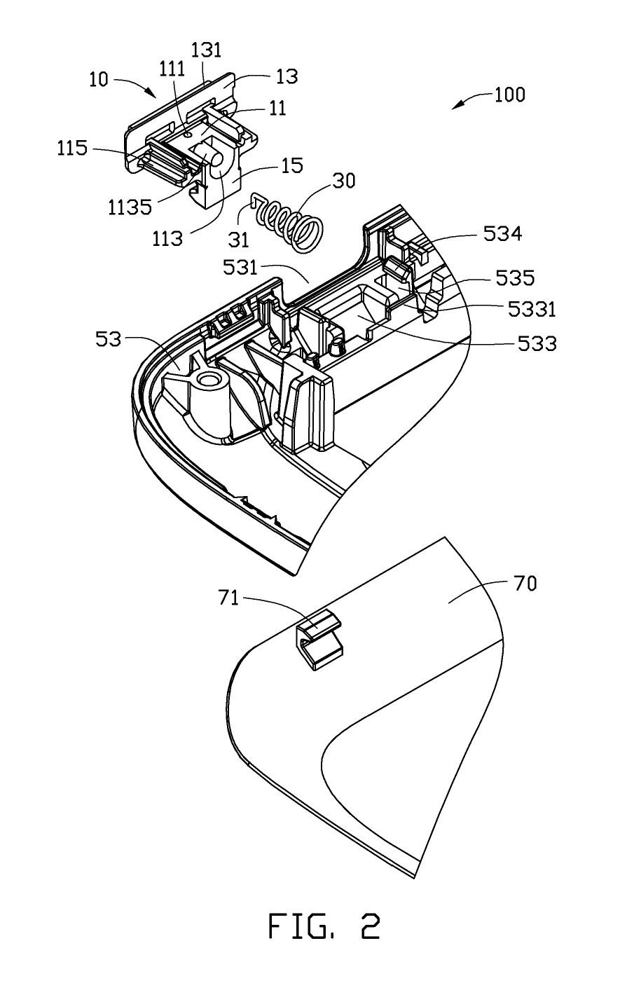

Referring to FIGS. 1 and 2, each button 10 includes a main body 11, a pressing plate 13 protruding from one end of the main body 11 and a latching portion 15 protruding from an opposite end of the main body 11. The pressing plate 13 has a pressing block projecting therefrom. The pressing block is smaller than the pressing plate 13 thereby forming a flange around the pressing block. The latching portion 15 is hooked for latching the cover 70 to the housing 50. The main body 11 defines a retaining hole 111 therein for retaining one end of the spring 30 to the main body 11. The main body 11 further defines a mounting groove 113 adjacent to the latching portion 15 and has a post 1135 located in the mounting groove 113. The post 1135 is sleeved by one end of the spring 30. The main body 11 further includes two sliding boards 115 formed at opposite sides of main body 11. The sliding boards 115 are slidably mounted to the housing 50 so the main body 11 is slidable relative to the housing 50.

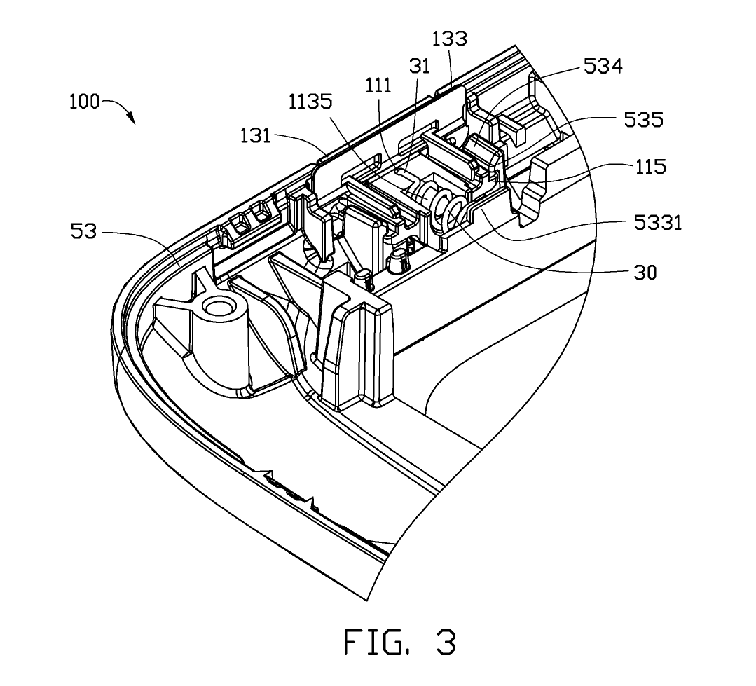

Referring to FIG. 3, each spring 30 has a retaining pin 31 extending from one end thereof. Each retaining pin 31 is retained in one of the retaining holes 111 to retain the springs 30 to their corresponding buttons 10. The springs 30 provide force for the button 10 to restore to its original state.

Referring to FIGS. 1 and 3, the housing 50 includes two opposite sidewalls 53, each sidewall 53 defines a receiving hole 531, and protrudes a resisting board 5331 from an inner surface thereof and aligned with the receiving hole 531. Each receiving hole 531 accommodates one of the pressing plates 13. Each resisting board 5331 resists one of the springs 30. Each sidewall 53 further defines a cutout 533 adjacent to a corresponding receiving hole 531. Each sidewall 53 could further include two opposite sliding blocks 534 formed at opposite sides of a corresponding cutout 533. Each sliding block 534 defines a sliding groove 535 opposing the other sliding block 534. Each sliding groove 535 slidably engages with one of the sliding boards 115 to enable the buttons 10 to be slidable relative to the housing 50.

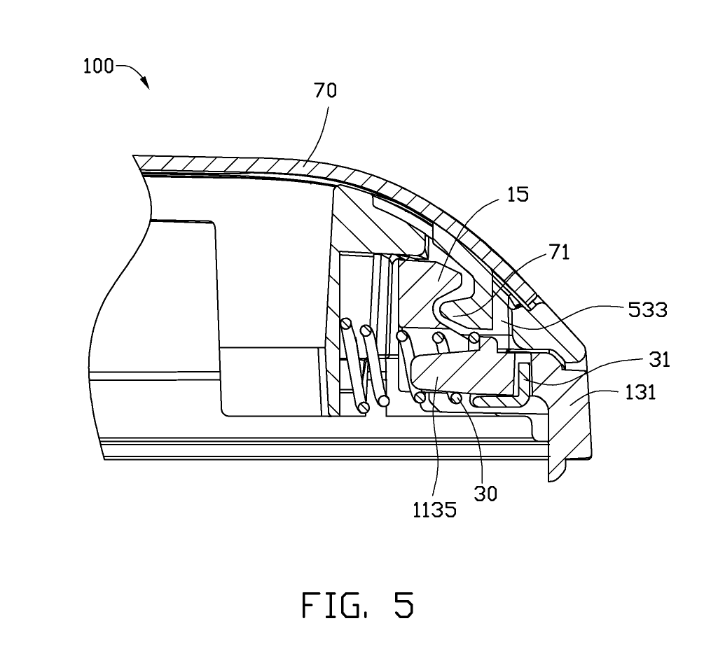

Referring to FIGS. 2 and 5, the cover 70 includes two hooks 71 respectively corresponding to the latching portions 15. When the cover 70 covers the housing 50, each hook 71 inserts into one of the cutouts 533 and then latches with their corresponding latching portion 15, to hold the cover 70 on the housing 50.

Referring to FIGS. 2 and 3, the assembly of the cover latching mechanism 100 will be described relative to one of the buttons 10 and a corresponding spring 30. However, such action equally applies to the other button 10 and corresponding spring 30. Firstly, the retaining pin 31 is retained in the retaining hole 111 with one end of the spring 30 sleeved on a corresponding post 1135. The button 10 is then mounted to the housing 50 so the pressing plate 13 is retained in corresponding receiving hole 531. Each sliding board 115 is accommodated in one of the sliding grooves 535 and the latching portion 15 is accommodated in the cutout 533. The other end of the spring 30 resists against a corresponding resisting board 5331. Each hook 71 latches with one of the latching portions 15 to latch the cover 70 to the housing 50.

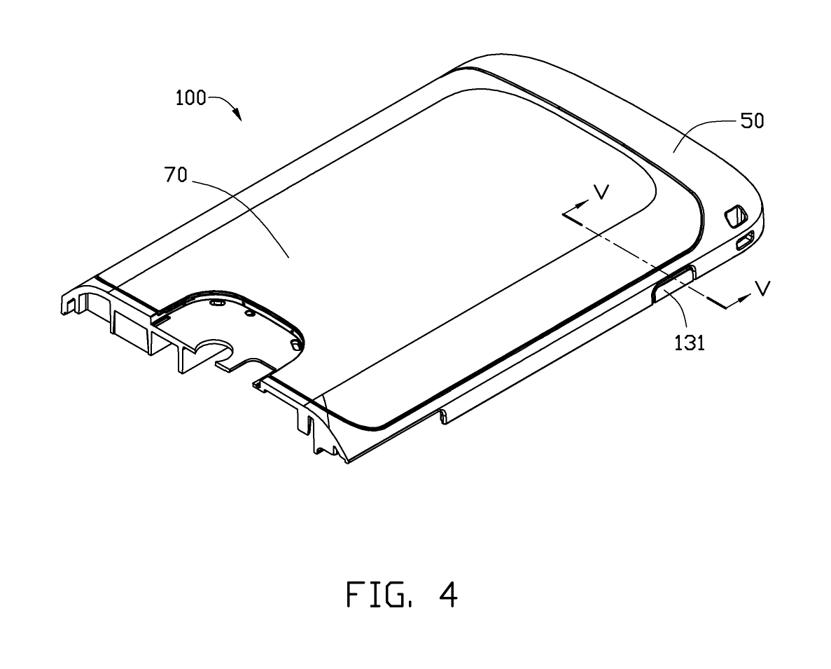

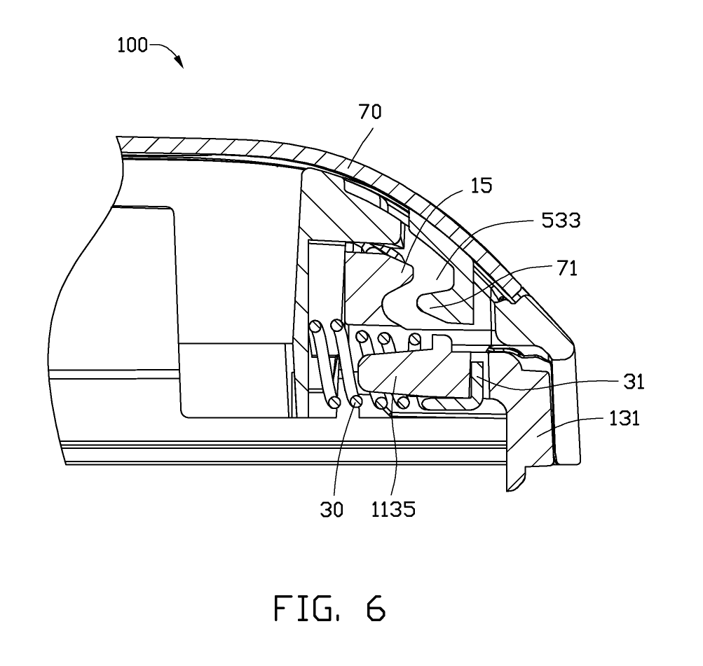

Referring to FIGS. 4 to 6, in use, the buttons 10 are pressed by an external force pressing the pressing blocks 131, so the sliding boards 115 slide in their corresponding sliding grooves 535, while compressing their corresponding springs 30, until the latching portions 15 are separated from corresponding hooks 71. Thus, the cover 70 can be detached from the housing 50. Then the buttons 10 are released to restore the springs 30, and the restored springs 30 push the button 10 to slide until the flange 133 resists the housing 50 to prevent the button 10 from separating from the housing 50.

It is to be understood, however, that even through numerous characteristics and advantages of the exemplary disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A cover latching mechanism comprising:
a housing
a cover;
a button slidably mounted to the housing and releasably latching with the cover; and
a spring mounted between the button and the housing;
wherein when the button is pressed, the button slides relative to the housing to compress the spring and release the button from latching with the cover.

2. The cover latching mechanism of claim 1, wherein a retaining pin protrudes from a first end of the spring; the button defining a retaining hole for retaining the retaining pin therein.

3. The cover latching mechanism of claim 2, wherein a post protrudes from the button, the first end of the spring wrapping around the post and resisting the button; the spring further includes a second end, the housing including a resisting board which resists the second end.

4. The cover latching mechanism of claim 1, wherein the button further includes a latching portion; a hook protrudes from the cover; and the hook latches with the latching portion.

5. The cover latching mechanism of claim 1, wherein sliding blocks protrude from opposite sides of the housing, and each sliding block defining a sliding groove therein; sliding boards protrude from sides of the button, each sliding board slidably accommodated in one of the sliding grooves.

6. The cover latching mechanism of claim 5, further comprising a pressing plate, and a pressing block protrudes from the pressing plate, the pressing block is smaller than the pressing plate so a flange is formed around the pressing block; the flange for resisting the housing to prevent the button from separating from the housing.

7. The cover latching mechanism of claim 6, wherein the housing includes a sidewall and a receiving hole defining in the sidewall; the pressing plate located in the receiving hole.

8. A cover latching mechanism comprising:
a housing
a cover;
a button slidably mounted to the housing; and
a spring exerting a force on the button to latch the button with the cover.

9. The cover latching mechanism of claim 8, wherein a retaining pin protruding from a first end of the spring; the button defining a retaining hole for retaining the retaining pin therein.

10. The cover latching mechanism of claim 9, wherein a post protrudes from the button, the first end of the spring wrapping around the post and resisting the button; the spring further includes a second end, the housing including a resisting board which resists the second end.

11. The cover latching mechanism of claim 8, wherein the button further includes a latching portion; a hook protrudes from the cover, and the hook latches with the latching portion.

12. The cover latching mechanism of claim 8, wherein sliding blocks protrudes from sides of the housing, and each sliding block defining a sliding groove therein; sliding boards protrudes from sides of the button, each sliding boards slidably accommodating in one of the sliding grooves.

13. The cover latching mechanism of claim 12, further comprising a pressing plate, and a pressing block protrudes from the pressing plate, the pressing block is smaller than the pressing plate so a flange is formed around the pressing block; the flange for resisting the housing to prevent the button from separating from the housing.

14. The cover latching mechanism of claim 13, wherein the housing includes a sidewall and a receiving hole defining in the sidewall; the pressing plate located in the receiving hole.
